(19) United States
(12) Patent Application Publication
(10) Pub. No.: US 2011/0101780 A1
(43) Pub. Date: May 5, 2011

(54) John-son power surge restorer battery powered electrical power supply

(76) Inventor: Wilbert B. Johnson, Cypress, TX (US)

(21) Appl. No.: 12/925,616

(22) Filed: Oct. 26, 2010

Related U.S. Application Data
(60) Provisional application No. 61/280,311, filed on Nov. 2, 2009.

(51) Int. Cl. H02J 7/34

(52) U.S. Cl. 307/66

(57) ABSTRACT

The present invention provides a portable rechargeable battery powered backup system for electrical devices, comprising a portable, multi-outlet power source designed to provide electrical current further comprising a four-wheeled pushcart having two shelves or compartments for supporting two rechargeable Lithium-Ion batteries

### CLAIM OF PRIORITY

This patent application claims priority under 35 USC 119 (e) (1) from U.S. Provisional Patent Application Ser. No. 61/280,311 filed Nov. 2, 2009, of common inventorship herewith entitled, “John-Son Power Surge Restorer Battery Powered Electrical Power Supply.”

### FIELD OF THE INVENTION

The present invention pertains to the field of electrical backup power supply, and more specifically to the field of portable non gasoline-powered backup power, such as a rechargeable battery-pack.

### BACKGROUND OF THE INVENTION

The prior art has put forth several designs for portable backup electrical power supplies. Among these are:

U.S. Pat. No. 4,376,250 to Baker describes a mobile apparatus for providing AC current from DC storage means.

U.S. Pat. No. 5,111,127 to Johnson describes a portable power supply utilizing a rechargeable battery for providing AC power.

U.S. Pat. No. 6,799,993 to Krieger describes a portable energy source with a distinct battery compartment whose cover is coupled to the power inverter.

None of these prior art references describe the present invention.

### SUMMARY OF THE INVENTION

It is an object of the present invention to provide an easy to use rechargeable portable device that provides backup electrical supply complete with multiple outlets.

### BRIEF DESCRIPTION OF THE DRAWINGS

FIG. 1 is a front perspective view of the device of the present invention.

FIG. 2 is close up view of the device controls and outlets of the device of the present invention.

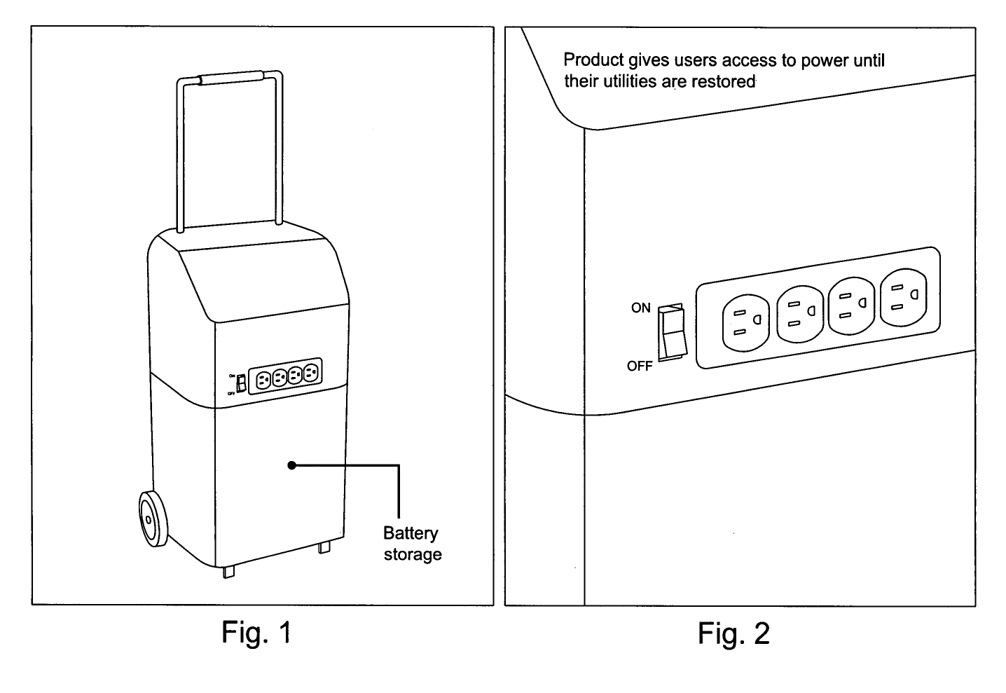

### DETAILED DESCRIPTION OF THE INVENTION

Electrical power is essentially for modern life. Access to electricity is taken for granted, however, the situation changes in an instant. A winter storm takes down the power lines, the cable and telephone. A tropical storm leaves us without the comfort of air-conditioning, bereft of our computer and television, microwave and stove. Once the power is down, the food in the refrigerator becomes a major concern. Some households have equipped themselves with gasoline-powered generators for such contingencies, but these generators are both loud and expensive, and because they release dangerous exhaust gases they must be used carefully and outside the structure.

The present invention, hereinafter referred to as The John-Son Power Surge Restorer, provides householders with a temporary, affordable, and clean source of emergency electricity in the event of a power outage.

Recognizing the need of consumers for a dependable, temporary source of household electricity in the event of a power outage, the present invention was developed. Simply stated, the John-Son Power Surge Restorer is a portable, battery-powered, multi-outlet power source designed to provide electrical current to household lights, appliances, and other necessary devices for 8 to 24 hours in the event of a power outage. Manufactured by the Batteries & Power Supplies industry, Standard Industrial Code 3691, the John-Son Power Surge Restorer is based on a four-wheeled pushcart. This cart is designed with two shelves or compartments for supporting the two rechargeable Lithium-Ion batteries of the system.

In terms of batteries, Lithium-Ion batteries have several distinct advantages for a system such as the John-Son Power Surge Restorer. Lithium-ion batteries have a higher energy density than most other types of rechargeable batteries. This means that for their size or weight they can store more energy than other rechargeable batteries. They also operate at higher voltages than other rechargeable batteries, which means a single cell can often be used rather than multiple NiMH or NiCd cells. Lithium-ion batteries also have a lower self discharge rate than other types of rechargeable batteries. This means that once they are charged, they retain their charge for a longer time than other types of rechargeable batteries. NiMH and NiCd batteries lose from 1% to 5% of their charge per day, (depending on the storage temperature) even if they are not installed in a device. Lithium-ion batteries retain their charge even after months of storage. So in summary, lithium-ion batteries are smaller or lighter, have a higher voltage and hold a charge much longer than other types of batteries.

The system of the present invention includes two rechargeable batteries, one of which, a reserve battery is available when the first becomes exhausted. The batteries connect to a power-bar or surge-protector strip. This strip is equipped with three to five outlets for the electrical plugs of household appliances, and is turned On or Off by a toggle switch mounted on the bar. The surge-protector strip also features an extension cord, and serves not only to power appliances, lights, and other electrical devices via the batteries, but when fitted to its extension cord and plugged into a wall outlet, recharges the batteries from the functioning household 110-volt current.

The owner simply maintains the batteries of the John-Son Power Surge Restorer by charging them during normal times of electrical usage, with a charge time of 8 to 12 hours per battery. Then they can use the John-Son Power Surge Restorer in times of electrical outage, the two batteries providing up to 24 hours of power for a variety of appliances and devices. Additional batteries are purchased to extend the temporal capacity of the system.

The John-Son Power Surge Restorer, a portable, battery-powered source of household electricity during power outages, presents a number of distinct and significant benefits and advantages. Foremost, the John-Son Power Surge Restorer provides temporary power to households suffering the effects of short-term outages. Most power outages are, in fact, short-term. When the power goes out, the householder simply rolls out the John-Son Power Surge Restorer cart, connects the surge-protector cord and strip to one of the two batteries, and then plugs in lamps, fans, a television or computer, any household appliance or device which operates on 110-volt current.

The John-Son Power Surge Restorer can be used in residences, offices, nursing homes, daycare centers or virtually anywhere that electricity is required. Because the system is supplemented by the purchase of additional batteries, the John-Son Power Surge Restorer provides power for days. Quiet, affordable and requiring no maintenance beyond periodic recharging of the batteries, this cost-effective temporary power system offers consumers a fine alternative to the purchase of a noisy, expensive, gasoline-powered generator.

A portable, battery-powered, temporary backup system for providing electrical current to household electronic devices and appliances in the event of a power outage, the rechargeable battery-pack of the John-Son Power Surge Restorer powers up to five devices or appliances for a period of two to three days, at a cost far less than that of a gasoline-powered generator. Easy to use and maintain, and eminently affordable, the John-Son Power Surge Restorer finds a wide and receptive market among the consumer households and business establishments alike.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A portable rechargeable battery powered backup system for electrical devices, comprising:
a portable, battery-powered, multi-outlet power source designed to provide electrical current further comprising a four-wheeled pushcart having two shelves or compartments for supporting two rechargeable Lithium-Ion batteries.

2. The system of claim 1 wherein one rechargeable battery is a reserve battery.

3. The system of claim 1 wherein the batteries connect to a power-bar or surge-protector strip.

4. The system of claim 3 wherein the strip comprises three to five outlets for electrical plugs.

5. The system of claim 3 wherein the strip is turned On or Off by a toggle switch mounted on the strip.

6. The system of claim 3 further comprising an extension cord, said cord having a first capability and a second capability, wherein the first capability is supplying power to appliances, and the second capability is recharging the system when plugged into a conventional grid-powered wall outlet.
